(19) United States
(12) Patent Application Publication
(10) Pub. No.: US 2007/0083915 A1
(43) Pub. Date: Apr. 12, 2007

(54) Method and system for dynamic adjustment of computer security based on personal proximity

(76) Inventors: Janani Janakiraman, Austin, TX (US); Lorin E. Ullman, Austin, TX (US); Carole R. Corley, Austin, TX (US)

Correspondence Address: IBM CORPORATION;INTELLECTUAL PROPERTY LAW, 11400 BURNET ROAD, AUSTIN, TX, 78758, US

(21) Appl. No.: 11/245,311

(22) Filed: Oct. 6, 2005

(51) Int. Cl. H04L 9/32

(52) U.S. Cl. 726/4

(57) ABSTRACT

A method, system, apparatus, or computer program product is presented for performing authorization operations with respect to a set of computational resources in a data processing system. Each person that accesses resources in a data processing system is associated with a personal proximity device, such as an electronic badge, the presence of which can be detected by appropriate detecting devices near the computational resources of the data processing system. A first person is permitted to access an authorized subset of computational resources, and the location of the first person can be determined by the detecting devices. At some point in time, the presence of a second person is detected and the corresponding location is determined. A spatial relationship between the locations of the first person and the second person is computed, e.g., a distance, the authorized privileges of the first person are modified based on the computed spatial relationship.

### BACKGROUND OF THE INVENTION

1. Field of the Invention

The present invention relates to an improved data processing system and, in particular, to a method and apparatus for computer security.

2. Description of Related Art

Computer security tools provide defensive mechanisms for limiting the ability of malicious users to cause harm to a computer system. Software-based intrusion detection applications can alert a computer administrator to suspicious activity so that the administrator can take actions to track suspicious computer activity and to modify computer systems and networks to prevent security breaches.

Many security breaches to computer systems, however, occur through neglect or forgetfulness of human beings that render computer systems physically vulnerable because they are physically available for unauthorized use. For example, a user may remain logged on to a computer workstation while away for lunch, and the unattended computer in the user's office is open for use by unauthorized persons. Even though a user's account or device may automatically logoff after a certain period of inactivity, there remains a period of time during which an unauthorized person may gain access to the user's account for malicious activity. Similar situations require greater physical control over vulnerable devices.

In addition to asserting better security practices over unattended devices, there are many situations in which security practices could be improved over attended devices, i.e. computational resources that are actively being used by someone yet still need to be protected from unauthorized use or observance. For example, some organizations, particularly government agencies and military departments, implement various types of security procedures over personnel. Different individuals within a single agency have different duties, and various levels of security clearance or various types of compartmentalized security access are given to individuals within the same organization in accordance with the duties of those individuals. In many cases, two persons within the same organizational unit might not be authorized to view the information that is handled by each other. These organizations can implement security procedures over computer systems that reflect security procedures that are applied to personnel; for example, each person is only authorized to access the computational resources that are necessary for his or her particular job. However, there is also a need to ensure that classified or confidential information is not inadvertently disclosed to persons that are not authorized to view such information.

Therefore, it would be advantageous to improve security over computational resources in conjunction with physical security in order to deter unauthorized activity on computer systems and to deter improper disclosure of information by users of computer systems that have varying levels of authorization privileges.

### SUMMARY OF THE INVENTION

A method, system, apparatus, or computer program product is presented for performing authorization operations with respect to a set of computational resources in a data processing system. Each person that accesses resources in a data processing system is associated with a personal proximity device, such as an electronic badge, the presence of which can be detected by appropriate detecting devices near the computational resources of the data processing system. A first person is permitted to access an authorized subset of computational resources, and the location of the first person can be determined by the detecting devices. At some point in time, the presence of a second person is detected and the corresponding location is determined. A spatial relationship between the locations of the first person and the second person is computed, e.g., a distance, the authorized privileges of the first person are modified based on the computed spatial relationship.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2 depicts a block diagram that shows a typical enterprise data processing system;

FIG. 3 depicts a block diagram that shows a portion of a physical building that employs a prior art personal physical proximity detector system to control various electrical devices within the building;

FIG. 4 depicts a block diagram that shows an overview of the integration of security events and authorization events in accordance with the present invention;

FIG. 5 depicts a timeline that shows the temporal relationship between detected security events and authorized sets of computational resources for a given user with respect to the scenario that is shown in FIG. 7;

FIG. 6 depicts a timeline that shows the temporal relationship between detected security events and authorized sets of computational resources for a given user with respect to the scenario that is shown in FIG. 8;

FIG. 7 depicts a diagram that shows a scenario in which two persons are shown in close physical proximity while only one person is authorized to use a particular computational resource;

FIG. 8 depicts a diagram that shows a scenario in which two persons are shown in close physical proximity while both persons are authorized to use a particular computational resource;

FIG. 9 depicts a diagram that shows types of spatial relationships between two persons that can trigger a change in a user's authorized set of computational resources;

FIGS. 10A-10F depicts a block diagram that shows a set of components in a data processing system for supporting the automatic modification of authorized privileges when the spatial relationship between two persons fulfills a condition for modifying authorizations in accordance with an embodiment of the present invention;

FIG. 11 depicts a flowchart that shows a process in a data processing system for modifying a user's authorization to access resources based on a spatial relationship between the locations of the user and another person in accordance with an embodiment of the present invention;

FIG. 12 depicts a flowchart that shows a process in a data processing system for restricting a user's authorization to access resources based on a spatial relationship between the locations of the user and another person in accordance with an embodiment of the present invention; and

FIG. 13 depicts a flowchart that shows a process in a data processing system for enhancing a user's authorization to access resources based on a spatial relationship between the locations of the user and another person in accordance with an embodiment of the present invention.

### DETAILED DESCRIPTION OF THE INVENTION

In general, the devices that may comprise or relate to the present invention include a wide variety of data processing technology. Therefore, as background, a typical organization of hardware and software components within a distributed data processing system is described prior to describing the present invention in more detail.

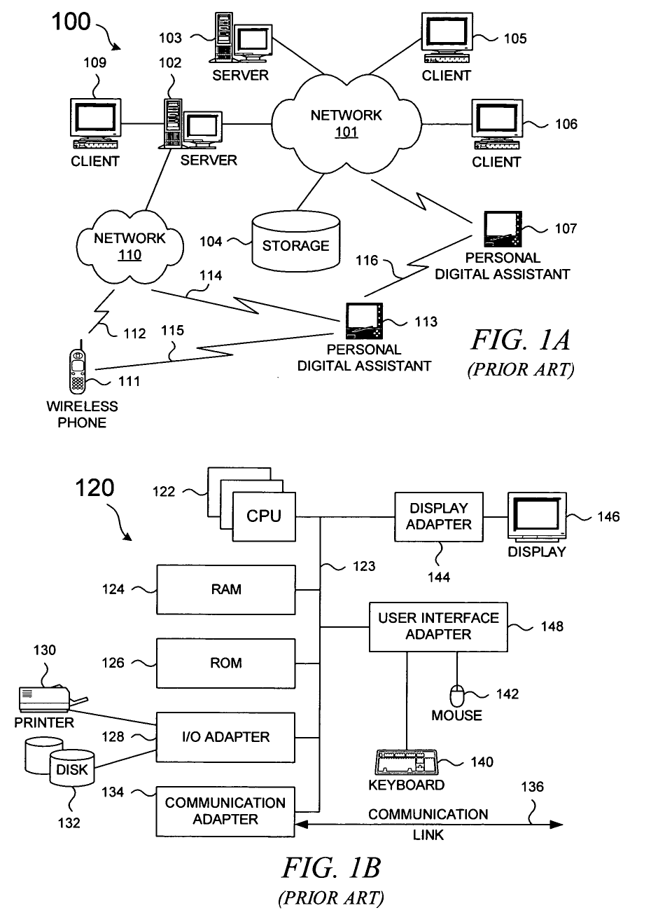

With reference now to the figures, FIG. 1A depicts a typical network of data processing systems, each of which may implement a portion of the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), File Transfer Protocol (FTP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as an audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files.

The present invention may be implemented on a variety of hardware and software platforms, as described above with respect to FIG. 1A and FIG. 1B. More specifically, though, the present invention is directed to an improved authorization processes within a data processing environment. Prior to describing the present invention in more detail, some aspects of a typical data processing environment that supports authorization operations are described.

With reference now to FIG. 2, a block diagram depicts a typical enterprise data processing system. Whereas FIG. 1A depicts a typical data processing system with clients and servers, in contrast, FIG. 2 shows a client within a network in relation to some of the server-side entities that may be used to support client requests to access resources. As in a typical computing environment, enterprise domain 200 hosts resources that user 202 can access, e.g., by using browser application 204 on client 206 through network 208; the computer network may be the Internet, an intranet, or other network, as shown in FIG. 1A.

Enterprise domain 200 supports multiple servers. Application servers 210 support controlled and/or uncontrolled resources through web-based applications or other types of back-end applications, including legacy applications. Reverse proxy server 214, or more simply, proxy server 214, performs a wide range of functions for enterprise domain 200. For example, proxy server 214 may cache web pages in order to mirror the content from an application server. Incoming and outgoing datastreams may be processed by input datastream filter 216 and output datastream filter 218, respectively, in order to perform various processing tasks on incoming requests and outgoing responses in accordance with goals and conditions that are specified within various policies or in accordance with a configuration of deployed software modules.

Session management unit 220 manages session identifiers, cached credentials, or other information with respect to sessions as recognized by proxy server 214. Web-based applications typically utilize various means to prompt users to enter authentication information, often as a username/password combination within an HTML form. In the example that is shown in FIG. 2, user 202 may be required to be authenticated before client 206 may have access to resources, after which a session is established for client 206. In an alternative embodiment, authentication and authorization operations are not performed prior to providing a user with access to resources on domain 200; a user session might be created without an accompanying authentication operation.

The above-noted entities within enterprise domain 200 represent typical entities within many computing environments. However, many enterprise domains have security features for controlling access to protected computational resources, such as a compliance server for IT security and other governance activities that are associated with users and their systems. A computational resource may be an electronic data processing device/subsystem/system, an application, an object, an executable code module, a document, a web page, a file, a database, a database record, various other types of functional units, various other types of information units, or various types of communication functions. A protected or controlled computational resource is a computational resource that is only accessible or retrievable if the requesting client or requesting user is authenticated and/or authorized; in some cases, an authenticated user is, by default, an authorized user. Authentication server 222 may support various authentication mechanisms, such as username/password, X.509 certificates, or secure tokens; multiple authentication servers could be dedicated to specialized authentication methods. Authorization server 224 may employ authorization database 226, which contains information such as access control lists 228, authorization policies 230, information about user groups or roles 232, and information about administrative users within a special administrative group 234. Using this information, authorization server 224 provides indications to proxy server 214 whether a specific request should be allowed to proceed, e.g., whether access to a controlled computational resource should be granted in response to a request from client 206.

The operator of enterprise domain 200 supports the physical devices of enterprise domain 200 within physical structures, and these physical devices and physical structures require electricity. Hence, it may be assumed that the operator of enterprise domain 200 controls an electrical subsystem through which electricity is provided for the devices and structures. It may also be assumed that the operator of enterprise domain 200 manages a security subsystem through which physical security is asserted over these physical devices and structures. Enterprise domain 200 contains electrical subsystem interface 236 for providing computational control from the components in the data processing system to electrical devices under the control of the operator of enterprise domain 200. Enterprise domain 200 also contains security subsystem interface 238 for providing computational control from the components in the data processing system to security-related devices under the control of the operator of enterprise domain 200.

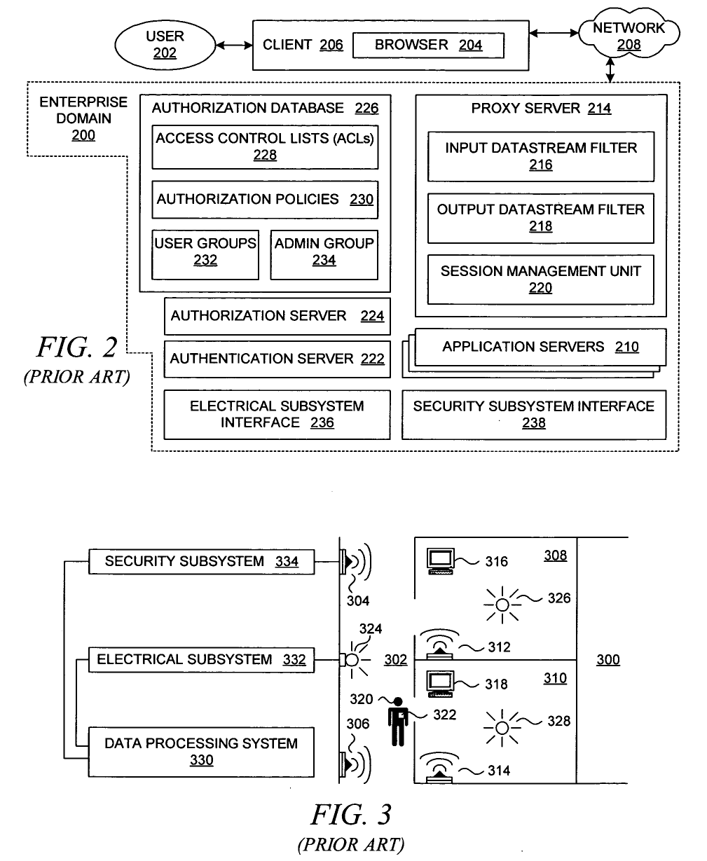

With reference now to FIG. 3, a block diagram depicts a portion of a physical building that employs a prior art personal physical proximity detector system to control various electrical devices within the building. Building 300 contains multiple offices, hallways, and other physical spaces. Hallway 302 contains electronic physical proximity devices 304 and 306, and offices 308 and 310 contain electronic physical proximity detecting devices 312 and 314, respectively, as well as computers 316 and 318, respectively. Person 320 wears or carries electronic physical proximity device 322, e.g., in the form of an electronic security badge, PDA, cell phone, or other computational device.

The electronic physical proximity detector subsystem may comprise one or more types of proximity detector technologies. For example, electronic physical proximity detector system may support so-called RFID (Radio Frequency Identifier) tags; in a typical RFID system, individual objects that are to be tracked are equipped with a small, inexpensive tag. The tag contains a transponder with a digital memory chip that is given a unique electronic code. The interrogator comprises an antenna packaged with a transceiver and decoder that emits a signal activating the RFID tag so it can read and write data to it. When an RFID tag passes through an electromagnetic zone, it detects the reader's activation signal. The reader decodes the data encoded in the tag's integrated circuit, and the data is passed to a host computer for processing. In the example that is shown in FIG. 3, electronic physical proximity device 304 may be an interrogator device, and electronic physical proximity device 322 may include the RFID tag, e.g., within an employee badge. As person 320 moves within building 300, the position of person 320 within building 300 can be determined by the activation information that is gathered by various interrogator devices within building 300 along with the known locations of the interrogator devices. Moreover, the identity of person 320 can be deduced by the information that is associated with the RFID tag within electronic physical proximity device 322.

Other types of RFID tags are based on technologies in which a passive RFID tag does not require a power source. For example, a particular passive RFID tag is uniquely identified by reflecting a unique signal when bombarded with a special signal. Similar features may be obtained through the use of different active and passive wireless technologies, including technologies such as Bluetooth, WiFi, cellular, augmented GPS (Global Positioning System), DGPS (differential GPS), etc. Moreover, some of these technologies may be combined and used within a single device, such as a cell phone with a GPS receiver.

Lights 324-328 and other electrical devices are components within electrical subsystem 332. Electronic physical proximity detecting device 312 and other devices assisting in proximity-detecting operations are components within an electronic physical proximity detector subsystem, which forms part of security subsystem 334 along with other security-related devices and/or subsystems.

Data processing system 330 interfaces with electrical subsystem 332 and security subsystem 334, which provide information to data processing system 330 in order to control devices within those subsystems. Based on the location of a person within building 300, a data processing system may control various electrical devices to operate the devices when there is a person nearby to those devices that requires the use of those devices. For example, lights 324-328 are only operated when there are persons nearby, thereby reducing electricity consumption and reducing the costs of operating the building.

More complex patterns of usage of the electrical devices may be programmatically asserted, especially when it is assumed that many electrical devices are connected to a network to receive control operations from a data processing system. For example, the local environment within a particular room or office may be controlled by an employee within the office through a computer-human interface in a computer program for managing the electrical devices; electrical devices within the office will exhibit operational behaviors that have been previously requested programmatically by the employee. In an exemplary scenario, the lighting in the office may be diminished while the employee is in the office, but if another employee enters the office, the lighting is increased and the volume of a radio is decreased.

As indicated above, there are prior art products that enable security over physical devices or physical locations, or as more specifically illustrated hereinabove, that enable control of electronic devices through the use of personal proximity detection devices. In addition, there are prior art products that provide security over computational resources. As is well-known, prior art solutions can integrate security systems over physical resources and computational resources within a data processing system.

Different aspects of a security system are described through the use of many concepts. Authentication operations involve the verification of a person's identity; the person's identity may be verified in many different ways that are reflective of the type of security system. In many security-related scenarios, a verified identity provides a basis for a minimal level of access for the person to a physical location, a physical device, or a computational resource. Thereafter, authorization operations are performed that allow determinations concerning whether a given person should be allowed to have one or more authorization privileges within a location or with respect to a computational resource.

Many security-related concepts are applicable to both physical security systems, i.e. systems that provide security over physical locations and physical devices, and computer security systems, i.e. system that provide security over computational resources. A computer security system may authenticate a person's identity through the programmatic presentation of a digital certificate or other type of computational security token. Thereafter, the person is authorized to access computational resources based on information that a data processing system has stored for the authorization privileges that are to be provided to the person. A physical security system may authenticate a person's identity through the use of a security badge, which often has a photograph of the legitimate possessor of the badge and may comprise an electronic component. When the security badge is presented as a physical security token, the presenting person is permitted to access a location or a device. Thereafter, the person is authorized to access additional locations or devices based on the ability to pass through physical authorization mechanisms, such as using keys or passcodes on doors that allow access to restricted locations or devices.

In many enterprises, security over computational resources may be implemented through a mixture of physical security and computational security, and in many cases, computational security is enhanced by physical security. Within a corporate setting, certain computational resources can only be accessed after obtaining physical access to certain locations or devices. Persons are required to pass through physical security procedures before obtaining physical access to devices, after which the persons are able to attempt to pass through computational security procedures when using those devices.

In some enterprises, security over computational resources may still be vulnerable in spite of multiple layers or types of security. In many situations, these security vulnerabilities arise due to human behavior, i.e. because computer systems need to be operated in a manner that is conducive to human behavior and human capabilities; when a computational resource is used by one person, another person often has the ability the exploit a human relationship between the persons to obtain security-sensitive information.

For example, many employees may be authorized to work in relatively close proximity with each other, e.g., within a building or on the same floor of a building, yet various groups of employees may have different authorization privileges with respect to computational resources. For financial or other reasons, it may not be cost-effective or practical for an enterprise to physically separate groups of employees into different physical areas based on the authorization privileges of those groups of employees with respect to computational resources; e.g., it may not be cost-effective to spread employees across multiple floors of a building based solely on the types of computational resources that the employees are authorized to access. In certain situations, though, some employees should not be allowed to observe the work of other employees as those other employees access specialized devices, programs, or other computational resources, even though each set of employees share offices within a building. The present invention is directed to a novel approach to integrating physical security operations and computer security operations.

Although an enterprise may attempt to assert security over physical resources and computational resources, the present invention recognizes that there may be some scenarios in which security over computational resources may be compromised because of the complexity of integrating security procedures over physical resources and security procedures over computational resources. Hence, the present invention is directed to a data processing system with improved security over computational resources by improving an integration of computational security with physical security that specifically employs personal proximity detection devices in various manners as described in more detail below with respect to the remaining figures.

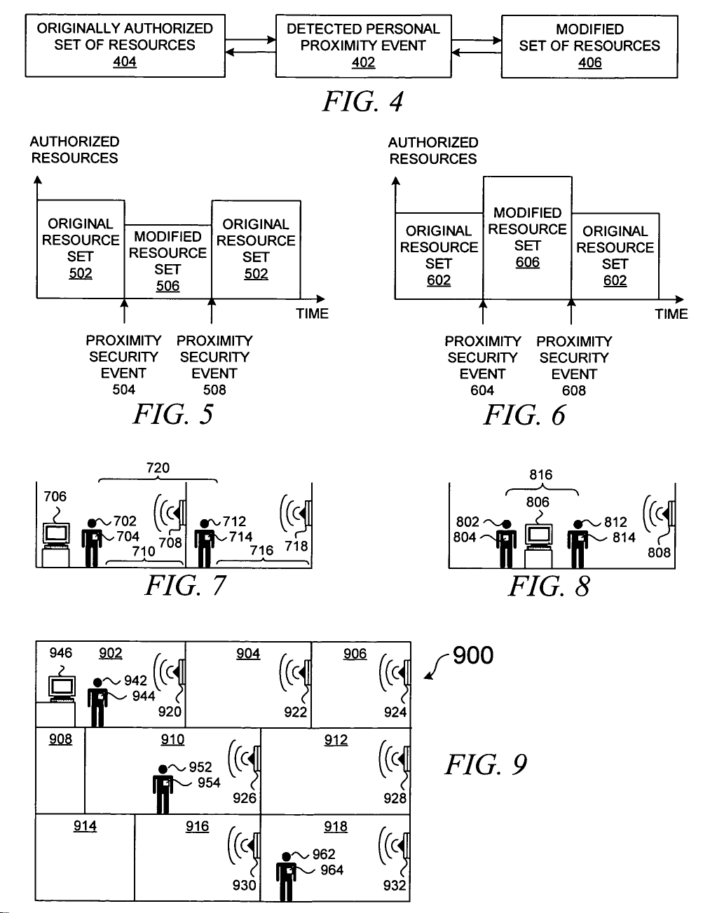

With reference now to FIG. 4, a block diagram depicts an overview of the integration of proximity security events and authorization events in accordance with the present invention. An enterprise is assumed to implement a physical security subsystem that includes personal proximity detection devices along with a computational security subsystem that manages different sets of authorization privileges for different users of a data processing system.

At some point in time, a user is initially authorized to access a specific set of computational resources. At some later point in time, a security event is detected through the use of a personal proximity detection device. In response to detection 402 of a proximity security event through activity of a personal proximity detection device, an originally or initially authorized set of computational resources 404 for a given user is modified in some manner to create a modified set of authorized computational resources 406 for that given user.

In a generalized physical security subsystem, a physical security event may be generated in a variety of manners, possibly by a variety of devices. The present invention is directed to proximity security events that are generated, or caused to be generated, by personal proximity detection devices; proximity security events may be considered to be a subclass of physical security events. A personal proximity detection device detects the presence or the lack of presence of a person or persons within a given proximity to the device, thereby generating or causing the generation of a proximity security event in response to activity or lack of activity by persons around a personal proximity detection device. The operational parameters of a personal proximity detection device may be configurable, e.g., the range of detection or other parameters. The manner in which the proximity security events are processed for use by a security management application may be configurable through programmable functionality within a security management application, e.g., as discussed in more detail below.

In response to detection 402 of yet another proximity security event through the operation of a personal proximity detection device, the modified set of authorized computational resources 406 can be subsequently restored to the originally authorized set of computational resources 404, or in some circumstances, to yet another different modified set of authorized computational resources.

With reference now to FIG. 5, a timeline illustrates the temporal relationship between detected security events and authorized sets of computational resources for a given user with respect to the scenario that is shown in more detail in FIG. 7. Whereas FIG. 4 illustrates a generalized modification in the authorization of resources in response to a proximity security event, FIG. 5 depicts a more specific scenario. Original resource set 502 represents an originally authorized set of resources for a person over a period of time before the occurrence of proximity security event 504. During this time period, the person is authorized to access multiple resources as indicated in original resource set 502.

However, when proximity security event 504 occurs, the originally authorized resource set for this person is modified to produce modified resource set 506. In other words, when a proximity security event occurs, a user's authorization privileges is diminished until some subsequent point in time. When proximity security event 508 occurs, the originally authorized resource set 502 is restored.

Using the timeline that is shown in FIG. 5, an embodiment of the present invention is able to provide heightened security by diminishing authorized access to resources in order to handle situations in which an operator of a data processing system desires to diminish a user's set of authorized resources in certain circumstances. Depending on the modified set of authorized resources, the user may be denied access to a resource that the user is already authorized to use or is already using; the denial of access may continue until the security condition that caused the security event is cleared. In this manner, a person who is not authorized to access a computational resource is denied the ability to observe or to otherwise surreptitiously access a resource that is being used by another person because the person who was authorized becomes unauthorized, thereby preventing the observance or the usage of the resource by the original user or the user with malicious intent in the nearby physical vicinity. While this may be inconvenient to the original user who was authorized to access the resource and may have already been using the resource, the present invention may be employed as a secondary safeguard to ensure that access to certain resources continue to be denied to an unauthorized person after the unauthorized person has thwarted some other form of physical security, e.g., such as entering a secure location through unauthorized means.

This functionality is useful in a variety of physical scenarios. For example, as noted above, it may not be cost-effective or practical for an enterprise to physically separate groups of employees into different physical areas based on the authorization privileges of those groups of employees with respect to computational resources; e.g., it may not be cost-effective to divide groups of employees onto multiple floors of a building based solely on the types of computational resources that the employees are authorized to access. Hence, an operator of a data processing system can have some security concerns over an environment in which there are persons who are not authorized to access certain computational resources yet who are physically authorized to be close to other persons who are authorized to access those computational resources. The present invention is able to integrate physical security and computational security to provide a novel solution for such scenarios; the scenario in which FIG. 5 is applicable is illustrated in more detail in FIG. 7.

With reference now to FIG. 6, a timeline illustrates the temporal relationship between detected security events and authorized sets of computational resources for a given user with respect to the scenario that is shown in more detail in FIG. 8. Again, whereas FIG. 4 illustrates a generalized modification in the authorization of resources in response to a proximity security event, FIG. 6 depicts a more specific scenario. Original resource set 602 represents an originally authorized set of resources for a person over a period of time before the occurrence of proximity security event 604. During this time period, the person is authorized to access multiple resources as indicated in original resource set 602.

However, when proximity security event 604 occurs, the originally authorized resource set for this person is modified to produce modified resource set 606. In other words, when a proximity security event occurs, a user's authorization privileges is enhanced until some subsequent point in time. When proximity security event 608 occurs, the originally authorized resource set 602 is restored.

Using the timeline that is shown in FIG. 6, an embodiment of the present invention is able to accommodate a situation in which security over a particular computational resource is somewhat diminished in a controlled manner for a short time and for a specific circumstance by allowing enhanced authorized access to resources in order to handle situations in which an operator of a data processing system desires to enhance a user's set of authorized resources. This functionality is useful in a variety of physical scenarios. Again, an operator of a data processing system can have some security concerns over an environment in which there are persons who are not authorized to access certain computational resources yet who are physically authorized to be close to other persons who are authorized to access those computational resources. The present invention is able to integrate physical security and computational security to provide a novel solution for such scenarios; the scenario in which FIG. 6 is applicable is illustrated in more detail in FIG. 8.

With reference now to FIG. 7, a diagram depicts a scenario in which two persons are shown in close physical proximity while only one person is authorized to use a particular computational resource. Person 702 wears or carries electronic physical proximity device 704, e.g., in the form of an electronic security badge, cell phone, PDA, or other electronic device, while using computational resource 706. As person 702 uses resource 706, e.g., within an office, proximity security events may be generated by personal proximity detection device 708 or may be generated in response to operations of personal proximity detection device 708, which may be accomplished in response to a polling query from a management application, in a periodic manner, or in some other manner, thereby reporting the location of person 702, either as an absolute coordinate location or in relation to personal proximity detection device 708, thereby allowing a computation of a data value that represents distance 710.

In the scenario that is shown in FIG. 7, person 702 is authorized to use resource 706 while person 712 is not authorized to use resource 706. At some point in time, person 702 initially attempts to use resource 706; it may be assumed that person 712 has not yet approached person 702. An authorization determination is made as to whether or not person 702 is allowed to use resource 706. Resource 706 is included within an originally authorized set of resources for person 702, and person 702 is permitted to use resource 706.

While person 702 is using resource 706, person 712 wears or carries electronic physical proximity device 714, e.g., within a hallway near the office in which person 702 is working. A physical security subsystem and/or an associated security management application processes proximity security events that are generated by the presence of electronic physical proximity device 714 and nearby personal proximity detection devices, which results in the determination of a location for person 712 and a data value that represents distance 716 between person 712 and personal proximity detection device 718. Given information about the locations of personal proximity detection device 708 and personal proximity detection device 718, distance 720 between person 702 and person 712 can be computed.

Meanwhile, person 702 is only permitted to use resource 706 while the physical environment or area around person 702 is secure, i.e. such that unauthorized persons are not able to observe or otherwise compromise the secure use of resource 706 by person 702. For example, at some point in time, person 712 approaches an area around person 702; it may be physically possible for person 712 to observe the work of person 702 through a window or by entering an unlocked door. Hence, the data processing system that supports computational resource 706 is configured to generate proximity security events under certain physical circumstances. In this scenario, a proximity security event is generated when person 712 moves within distance 720 of person 702, and the proximity security event causes a reevaluation of the set of authorized resources for person 702. In this example, given that person 712 is not authorized to use resource 706, the authorization for person 702 to use resource 706 is suspended, thereby modifying the authorized set of resources for person 702. Because person 702 is now unauthorized to use resource 706, person 702 is denied access to resource 706 in some appropriate manner, e.g., by temporarily being forced to logout of resource 706, thereby also denying person 712 of the ability to observe the use of resource 706. Various options for denying or suspending authorized access to a resource are discussed in more detail below.

Person 702 may again become authorized to use resource 706 at some subsequent point in time, e.g., when person 712 is not within distance 720 of person 702. However, the condition for removing or suspending an authorized privilege to access a computational resource and the condition for restoring a previously authorized privilege to access a computational resource do not necessarily have to be identical. For example, person 702 may be allowed to access resource 706 only after person 712 moves away from person 702 for a specific period of time or only after person 712 moves away a distance that is much greater than distance 720.

Alternatively, person 702 may be denied access to resource 706 until a computational condition is reset; the computational condition may be set upon the detection of person 712 near resource 706. After a restrictive parameter is reset, the originally authorized set of resources for person 702 is restored. This particular requirement may be useful if the detection of person 712 near personal proximity detection devices 708 or 718 was unexpected, e.g., if person 712 was unauthorized to be physically located near the work area of person 702 or near resource 706. The circumstances of this incident may need to be investigated by security personnel before person 702 is again authorized to access resource 706; after a potential security breach is investigated and resolved, a restrictive parameter may be reset through an appropriate computational or administrative procedure.

Depending upon the manner in which an authorized privilege is removed or suspended, person 702 could be warned or notified of an impending denial of a previously authorized privilege and the conditions that have caused the modification to the authorized resource set of person 702. Similarly, person 702 could be notified or otherwise informed of the status of the condition or conditions that caused the resource to become unauthorized with respect to person 702.

With reference now to FIG. 8, a diagram depicts a scenario in which two persons are shown in close physical proximity while both persons are authorized to use a particular computational resource. Person 802 wears or carries electronic physical proximity device 804, e.g., in the form of an electronic security badge or other electronic device. Person 802 is in close proximity to computational resource 806 and personal proximity detection device 808. Proximity security events may be generated by personal proximity detection device 808 or may be generated in response to operations of personal proximity detection device 808, thereby reporting the location of person 802.

Person 812 wears or carries electronic physical proximity device 814, e.g., in the form of an electronic security badge or other electronic device, and person 812 is also in close proximity to computational resource 806 and personal proximity detection device 808. Proximity security events may be generated by personal proximity detection device 808 or may be generated in response to operations of personal proximity detection device 808, thereby reporting the location of person 812. Using the location of person 802 and the location of person 812, distance 814 between person 802 and person 812 can be computed as a data value.

In the scenario that is shown in FIG. 8, person 802 is authorized to use resource 806 while person 812 is not authorized to use resource 806. At some point in time, person 812 initially attempts to use resource 806; it may be assumed that person 802 has not yet approached person 812. An authorization determination is made as to whether or not person 812 is allowed to use resource 806. Resource 806 is not included within an originally authorized set of resources for person 812, and person 812 is denied access to resource and is not permitted to use resource 806.

However, person 812 is permitted to use resource 806 while the physical environment or area around person 812 includes person 802 or similar person who is authorized to use resource 806, thereby enabling authorized persons to observe or otherwise control the secure use of resource 806 by person 812. For example, at some point in time, person 802 approaches an area around person 812; in this example, it may be assumed that it is physically possible for person 802 to observe or supervise the work of person 812 in some manner. The data processing system that supports computational resource 806 is configured to generate proximity security events under certain physical circumstances. In this scenario, a proximity security event is generated when person 802 moves within distance 816 of person 812, and the proximity security event causes a reevaluation of the set of authorized resources for person 812. In this example, given that person 802 is authorized to use resource 806, the authorization for person 812 to use resource 806 becomes enabled, thereby modifying the authorized set of resources for person 812. Because person 812 is now unauthorized to use resource 806, person 812 is permitted access to resource 806 in some appropriate manner, e.g., by temporarily being able to login to resource 806, thereby also providing person 802 of the ability to observe the use of resource 806 by person 812.

Person 812 may again become denied to use resource 806 at some subsequent point in time, e.g., when person 802 is not within distance 816 of person 812. However, the condition for enabling an authorized privilege to access a computational resource and the condition for removing or suspending a previously authorized privilege to access a computational resource do not necessarily have to be identical. For example, person 812 may be denied access to resource 806 only after person 802 moves away from person 812 for a specific period of time or only after person 802 moves away a distance that is much greater than distance 816. Alternatively, the use of resource 806 by person 812 may be automatically denied upon expiration of a predetermined time period. In yet another alternative embodiment, the use of resource 806 by person 812 may be automatically denied upon a standard conclusion of the use of resource 806, i.e., through a normal course of operation of resource 806, thereby allowing person 812 to use resource 806 until no longer required by person 812.

With reference now to FIG. 9, a diagram illustrates types of spatial relationships between two persons that can trigger a change in a user's authorized set of computational resources. FIGS. 7 and 8 are diagrams that illustrate that a spatial relationship that triggers a change in a user's authorized set of computational resources may be based upon a physical distance between the user's detected position and the detected position of another person. In contrast, FIG. 9 is a diagram that illustrates that a spatial relationship between a user and another person which triggers a change in a user's authorized set of computational resources may be based upon a difference in one or more spatial characteristics of the user's detected position and the detected position of the other person.

Building 900 contains multiple rooms 902-918. Some of these rooms contain personal proximity detection devices 920-932. In particular, room 902 contains personal proximity detection device 920; room 910 contains personal proximity detection device 926; and room 916 contains personal proximity detection device 930. Person 942 wears or carries electronic physical proximity device 944 and desires to use computational resource 946 in room 902. Person 952 wears or carries electronic physical proximity device 954. Person 962 wears or carries electronic physical proximity device 964. In the scenario that is shown in FIG. 9, person 942 is authorized to use resource 946 while person 952 and person 962 are not authorized to use resource 946.

At some point in time, person 942 initially attempts to use resource 946; it may be assumed that person 952 and person 962 have not yet entered building 900. An authorization determination is made as to whether or not person 942 is allowed to use resource 946. Resource 946 is included within an originally authorized set of resources for person 942, and person 942 is permitted to use resource 946. Person 942 is only permitted to use resource 946 while the physical environment or area around person 942 is secure, i.e. such that unauthorized persons are not able to observe or otherwise compromise the secure use of resource 946 by person 942.

At some subsequent point in time, person 952 enters building 900 and proceeds to room 910. Room 910 is on a different floor than room 902 in which person 942 is using resource 946. Although person 952 moves within a relatively small distance of person 942, it is physically impossible for person 952 to observe the work of person 942, e.g., through a window or by immediately entering an unlocked door. More importantly, it is not possible for person 962 to quickly move from room 910 to some location close to room 902. Hence, based on configuration information that allows a security management application to understand the spatial relationship between person 942 and person 952, i.e. the physical barriers between person 942 and person 952 and the improbability of person 952 causing an immediate security breach with respect to the use of resource 946 by person 942, the processing of information about the location of person 952 does not cause a modification in the authorized set of resources for person 942; person 942 remains authorized to continue using resource 946.

Meanwhile, at some point in time, person 962 enters building 900 and proceeds to room 918. Room 918 is on a different floor than room 902 in which person 942 is using resource 946. Person 962 is not within a relatively small distance of person 942, and it is physically impossible for person 962 to observe the work of person 942, e.g., through a window or by immediately entering an unlocked door.

However, based on configuration information that allows a security management application to understand the spatial relationship between person 942 and person 962, i.e. the physical barriers between person 942 and person 962 and the possibility of person 962 causing an immediate security breach with respect to the use of resource 946 by person 942, the processing of information about the location of person 962 causes a modification in the authorized set of resources for person 942; person 942 becomes unauthorized to continue using resource 946.

For example, person 962 could quickly approach an area in building 900 that contains an elevator that would allow person 962 to quickly move from room 918 to room 902, thereby subsequently allowing person 962 to observe the work of person 942 through a window or by entering an unlocked door. Hence, the data processing system that supports computational resource 946 is configured to generate proximity security events under certain physical circumstances. In this scenario, a proximity security event is generated when person 962 enters room 918, as detected by personal proximity detection device 932, and the proximity security event causes a reevaluation of the set of authorized resources for person 942. In this example, given that person 962 is not authorized to use resource 946, the authorization for person 942 to use resource 946 is suspended, thereby modifying the authorized set of resources for person 942. Because person 942 is now unauthorized to use resource 946, person 942 is denied access to resource 946 in some appropriate manner, e.g., by temporarily being forced to logoff resource 946, thereby also denying person 962 of the ability to observe the use of resource 946 if person 962 quickly moved to a location in or near room 902. In this manner, the modification of previously authorized privileges can be based on generalized spatial relationships between the locations of persons in addition to or in place of a specific distance between persons.

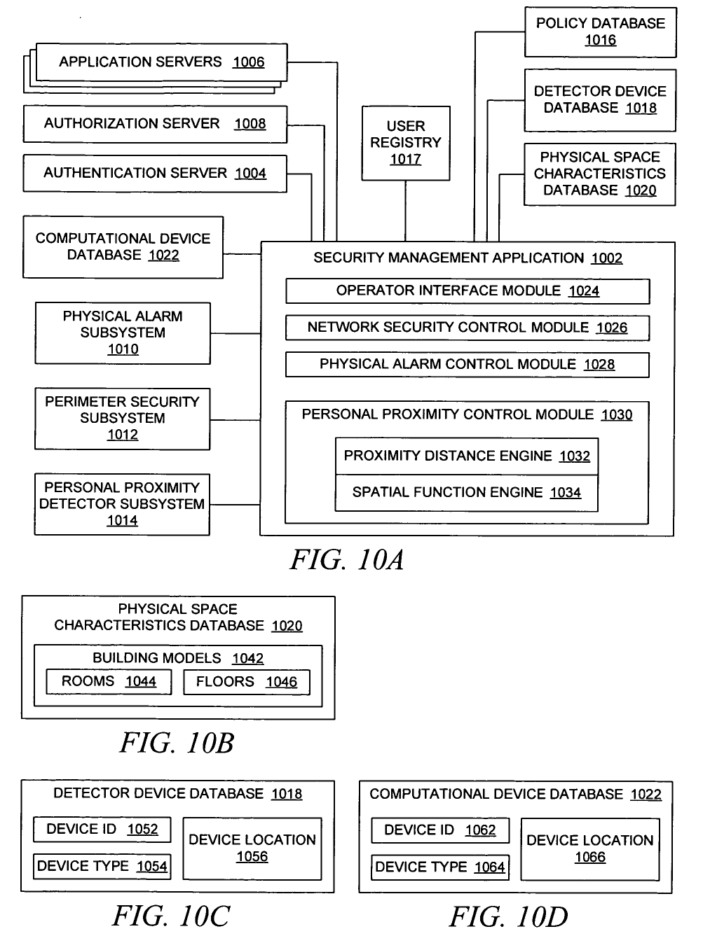

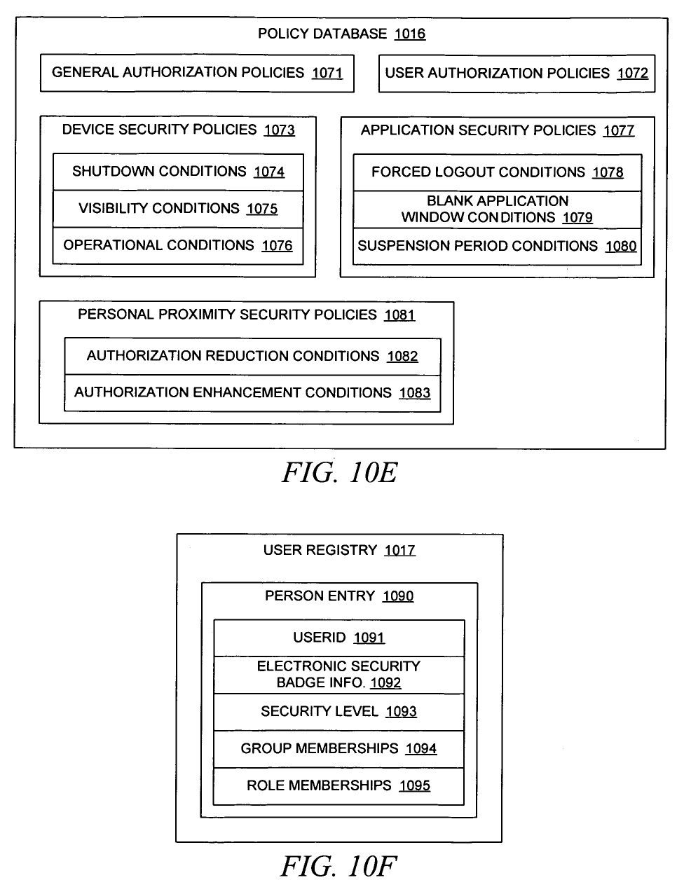

With reference now to FIGS. 10A-10F, a set of block diagrams depict components in a data processing system for supporting the automatic modification of authorized privileges when the spatial relationship between two persons fulfills a condition for modifying authorizations in accordance with an embodiment of the present invention. Referring now to FIG. 10A, security management application 1002 provides centralized control for supporting administrative actions with respect to physical security operations and computational security operations. Security management application 1002 resides within a larger data processing system, some of which is not shown in the figure. Authentication server 1004 verifies identities of users of the data processing system. Application servers 1006 provide support for executing applications that are used by those users. Authorization server 1008 determines whether or not a user is authorized to access a computational resource, such as an application server.

Security management application 1002 integrates operations from various types of security subsystems. Physical alarm subsystem 1010 monitors various physical conditions within an enterprise, such as fire alarms, smoke detectors, etc., using appropriate devices throughout the enterprise. Perimeter security subsystem 1012 monitors security devices around a perimeter of the enterprise for detecting unauthorized intruders or trespassers, e.g., through the use of motion detectors, devices for detecting the opening of closed doors and windows, etc. Personal proximity detector subsystem 1014 comprises an assortment of proximity detector devices for detecting the presence of persons via an association of the persons with electronic physical proximity devices, such as electronic ID badges, PDAs, or other electronic devices.

Security management application 1002 may require the input of various types of data that may be stored in any appropriate datastore: policy database 1016; user registry 1017; detector device database 1018; physical space characteristics database 1020; and computational device database 1022, each of which are described in more detail below.

Security management application 1002 contains various types of components or modules for supporting specific aspects of its operations. Operator interface module 1024 supports a user interface for an administrative user. Network security control module 1026 supports specific operations with respect to network security. Physical alarm control module 1028 provides support for reporting and canceling physical alarms.

Personal proximity control module 1030 provides support for handling information that is gathered by personal proximity detector subsystem 1014. Personal proximity control module 1030 generates and processes proximity security events as necessary; for example, not every detected movement of a person nor detected presence of a person at a location is a new movement or detected presence compared with information that may have been gathered in the very recent past, so the generation of proximity security events may be configurable with respect to sensitivity, priority of security operations, etc. Proximity distance engine 1032 computes distances between proximity detection events, whereas spatial function engine 1034 computes more generalized spatial relationships between proximity detection events.

Referring to FIG. 10B, additional detail is provided for some of the information that may be stored within physical space characteristics database 1020, which contains information about the physical plant of an enterprise. Building models 1042 contains programmatic models from which information can be extracted, such as locations of buildings, dimensions of building, location and sizes of rooms 1044, location and dimensions of spaces within floors 1046, etc. Information from physical space characteristics database 1020 can be used to compute spatial relationships between persons based on the detected locations of those persons; after a spatial relationship for the two persons is determined, e.g., that the two persons are located on the same floor or in the same room, then various policies or other types of conditions may be checked to determine whether or not the authorized privileges of one of those persons for accessing resources should be modified.

Referring to FIG. 10C, additional detail is provided for some of the information that may be stored within detector device database 1018, which provides information about the personal proximity detector devices of personal proximity detector subsystem 1014. Detector device database 1018 may contain an entry for each detector device, and each entry may contain device ID 1052, device type indicator 1054, and device location 1056. When a detector device reports an event, such as the movement of a person into a nearby area, security management application 1002 can obtain additional information for determining spatial relationships between the person and other persons in order to determine whether or not the authorized privileges of one of those persons should be modified.

Referring to FIG. 10D, additional detail is provided for some of the information that may be stored within computational device database 1022, which provides information about computational devices within the data processing system, such as laptop computers, desktop computers, printers, display devices, etc. Computational device database 1022 may contain an entry for each computational device, and each entry may contain device ID 1062, device type indicator 1064, and device location 1066. When the authorized privileges of someone is modified, then security management application 1002 may need to control a computational device, possibly via an electrical subsystem, to deny access to the computational device; information within computational device database 1022 may provide information that is required to select an appropriate policy that dictates the appropriate actions to be performed when a person's authorized set of resources is modified due to the presence of another person.

Referring to FIG. 10E, additional detail is provided for some of the information that may be stored within policy database 1016. Policy database 1016, which may also be accessed by authorization server 1004, contains various types of policies that are configurable to control the operation of various aspects of the overall data processing system. In general, a policy specifies a rule or a condition to be checked against a set of input parameters in order to determine whether a specified action should be taken when an given event occurs or when warranted circumstances arise.

General authorization policies 1071 may apply to all users, e.g., various enterprise-wide policies pertaining to work schedules. User authorization policies 1072 may contain unique policies for persons, e.g., a particular policy would only apply to a given person, thereby enabling the system management application to handle needs of employees or other persons on an individual basis.

Device security policies 1073 are policies that pertain to conditions over various types of devices and the manner in which access can be denied on the device after it has been previously granted. For example, device security policies 1073 may indicate: shutdown conditions 1074 for determining when a device needs to be shutdown in order to prevent further access; visibility conditions 1075 for determining when a display device or other type of presentation device needs to be disabled or cleared in order to temporarily protect the confidentiality of information that appears on the device; and operational conditions 1076 for determining when the device should be operationally disabled.

Application security policies 1077 are policies that pertain to conditions over various software applications and the manner in which access can be denied on the application after it has been previously granted. For example, application security policies 1077 may indicate: forced logout conditions 1078 for determining when a user should be forcibly logged off an application; blank application window conditions 1079 for determining when to clear an application window to prevent disclosure of the information within the window; and suspension period conditions 1080 for suspending any additional user input or application output for a predetermined or an indefinite period of time.

Personal proximity security policies 1081 are policies that pertain to conditions for determining when authorization privileges should be modified when personal proximity detection devices have detected that certain persons are separated by specified or predetermined spatial relationships. Personal proximity security policies 1081 may indicate authorization reduction conditions 1082 that specify certain conditions during which the authorized privileges of a user should be reduced. For example, with respect to a particular type of resource, it may not be permissible for employees that work on different projects to observe the work of the employees on the other project; employees that work on a particular project are assigned a policy attribute for a specific group membership. A personal proximity security policy may specify that when two or more persons having different group membership attributes are located within a certain distance of each other, then the use of a resource is denied; the operational manner in which access to the resource is denied may be provided by another policy.

In contrast, personal proximity security policies 1081 may also indicate authorization enhancement conditions 1083 that specify certain conditions during which the authorized privileges of a user should be increased. For example, a supervisor may be assigned a supervisor employee attribute, and a supervised employee may be assigned a supervised employee attribute. A personal proximity security policy may specify that when a supervisor and a supervised employee are located within a certain distance of each other, then the use of a resource by the supervised employee is permitted.

Referring to FIG. 10F, additional detail is provided for some of the information that may be stored within user registry database 1017. Each person that uses computational resources within a data processing system may be assumed to have a person entry within user registry database 1017. Person entry 1090 contains userID 1091, which is a unique identifier that a person uses to perform authentication operations. Electronic security badge information 1092 includes information, such as a serial ID number, for the electronic security badge that has been assigned to a person; when the security badge is worn or carried, the personal proximity detector devices can report the presence of the badge, thereby allowing the location and the identity of the person who is associated with the badge to be determined. Security level 1093 is an indication of the security clearance of the person, which is used as an input to determine the authorized privileges for the person. Group memberships 1094 indicate the groups to which the person belongs, such as a project, a corporate department, etc. Role memberships 1095 indicate the types of roles that may be performed by the person, such as supervisor or supervised employee.

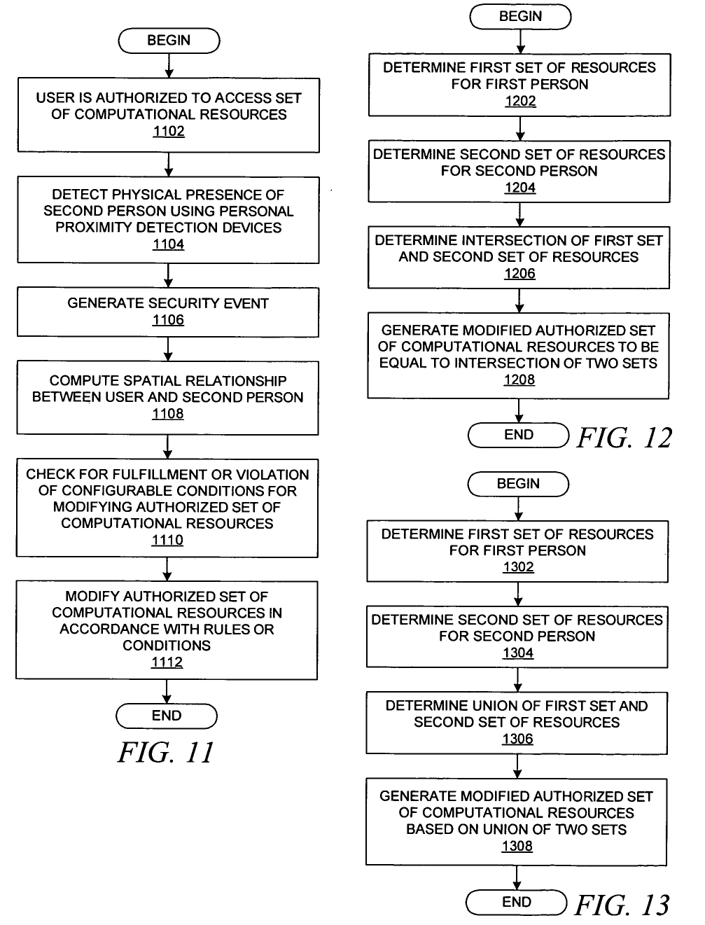

With reference now to FIG. 11, a flowchart depicts a process in a data processing system for modifying a user's authorization to access resources based on a spatial relationship between the locations of the user and another person in accordance with an embodiment of the present invention. The process commences when a user is authorized to access a set of computational resources (step 1102). At some point in time, the physical presence of a second person is detected through the use of personal proximity detection devices (step 1104), and in response to the physical detection, a proximity security event is programmatically generated (step 1106). It should be noted that a general change in conditions, including the movement of the second person away from a location may trigger a proximity security event.

In response to the proximity security event, a spatial relationship between the user and the second person is computed based on the detected locations of the user and the second person (step 1108). The spatial relationship is represented by a set of one or more data values, e.g., a distance value or data values that characterize the locations of the persons within a structure. Those data values for the spatial relationship are used as inputs to evaluating rules, policies, and/or other formats for administratively controlling the specification of conditions about sensitive security requirements for restricting or allowing these two persons to be simultaneously located within a certain area while one of the persons is authorized to access certain computational resources.

Using the data values that represent the spatial relationship, a determination is made as to whether or not configurable conditions are fulfilled or violated for modifying the authorized set of computational resources for the user (step 1110). If so, then the authorized set of resources for the user is modified in accordance with the rules, conditions, policies, etc. (step 1112), and the process is concluded. It should be noted that the authorized set of resources for the user is modified whether or not the user is already using one or more of the resources in the modified authorized set of resources. If the user is already using one of the resources, and the user becomes unauthorized with respect to the resource that is being used, then the user is denied further access to the resource in an appropriate manner for an appropriate period of time as controlled by the authorization conditions or policies, e.g., while the second person is located within a certain area that triggers the restrictive authorization policy.

With reference now to FIG. 12, a flowchart depicts a process in a data processing system for restricting a user's authorization to access resources based on a spatial relationship between the locations of the user and another person in accordance with an embodiment of the present invention. The process that is shown in FIG. 12 illustrates an example for step 1112 in FIG. 11, or more specifically with respect to FIG. 12, a manner in which an authorized set of resources can be reduced to restrict the actions of a user after the presence of a second person is detected in a location for which an authorization policy or authorization mechanism requires a reduction in authorized privileges in order to enhance the security of the situation.

The process commences by determining a first set of authorized resources for a first person (step 1202) and then determining a second set of authorized resources for a second person (step 1204). An intersection of these two sets is then computed (step 1206), and a modified authorized set of resources for the first user (and/or the second user, if required) is set equal to or less than the intersection of the two sets of resources (step 1208), thereby concluding the process. In this manner, the computational resources that the first user/person (and/or a second user/person) may access is restricted to less than or equal to the resources that both the first person and second person can access, thereby ensuring that the second person cannot maliciously or surreptitiously observe or otherwise access a resource to which the second person is not authorized.

With reference now to FIG. 13, a flowchart depicts a process in a data processing system for enhancing a user's authorization to access resources based on a spatial relationship between the locations of the user and another person in accordance with an embodiment of the present invention. The process that is shown in FIG. 13 illustrates an example for step 1112 in FIG. 11, or more specifically with respect to FIG. 13, a manner in which an authorized set of resources can be increased to enhance the actions of a user after the presence of a second person is detected in a location for which an authorization policy or authorization mechanism allows an enhancement in authorized privileges.

The process commences by determining a first set of authorized resources for a first person (step 1302) and then determining a second set of authorized resources for a second person (step 1304). An union of these two sets is then computed (step 1306), and a modified authorized set of resources for the first user is set equal to or less than the union of the two sets of resources (step 1308), thereby concluding the process. In this manner, the computational resources that the first user/person may access is increased to less than or equal to the resources that the first person or the second person can access; in other words, the first person gains authorized access to one or more resources that the second person is authorized to access or possibly all resources that the second person is authorized to access. The presence of the second person can temporarily enhance the resources that are available to the first person, which may be useful in certain situations, such as when the second person is a supervisor who allows access to a resource for the first person, who is a supervised employee.

The advantages of the present invention should be apparent in view of the detailed description that is provided above. The present invention is directed to a data processing system with improved security over computational resources by improving an integration of computational security with physical security that specifically employs personal proximity detection devices. A user is initially authorized to access a specific set of computational resources, but upon the detection of the presence of a person through the use of a personal proximity detection device and the satisfaction of a condition based on the detected location or presence of the person, the user's authorized set of computational resources is modified. Depending on the modified set of authorized resources, the user may be denied access to a resource that the user is already authorized to use or is already using; the denial of access may continue until the security condition that caused the security event is cleared. In this manner, a person who is not authorized to access a computational resource is denied the ability to observe or to otherwise surreptitiously access a resource that is being used by another person because the person who was authorized becomes unauthorized, thereby preventing the observance or the usage of the resource by anyone in the nearby physical vicinity.

The functionality of the present invention is particularly useful for situations in which an operator of a data processing system needs to allow temporary physical access to unauthorized persons to restricted areas that contain security-sensitive computational resources. For example, a temporary electronic ID badge would be provided to the contractor, and the security subsystems would be configured to accept the proximity detection of the location of the temporary badge within certain areas. A vendor or a contractor who is repairing a computational device could be positionally limited only to the areas in which access is required to perform a particular task. The contractor would be allowed to access appropriate computational resources within those limited areas only when escorted or observed by a person who is authorized to access the computational resources. In addition, the presence of the contractor would cause other users in the nearby area to have diminished access to resources for that temporary period, thereby denying a situation in which the contractor might accidentally or surreptitiously observe or access a computational resource that is not required for the maintenance or repair procedure.

As another example, an operator of a data processing system may need to allow temporary physical access to a security-escorted visitor of a facility so that the visitor may perform some type of administrative duty. As the visitor moves within the facility, the detection of the position of the visitor triggers additional security measures to deny access to computational resources or to deny observance of the usage of computational resources.

It should be noted that the present invention may be implemented in association with a variety of authentication and authorization applications, and the embodiments of the present invention that are depicted herein should not be interpreted as limiting the scope of the present invention with respect to a configuration of authentication and authorization services.

It is important to note that while the present invention has been described in the context of a fully functioning data processing system, those of ordinary skill in the art will appreciate that some of the processes associated with the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

Certain computational tasks may be described as being performed by functional units. A functional unit may be represented by a routine, a subroutine, a process, a subprocess, a procedure, a function, a method, an object-oriented object, a software module, an applet, a plug-in, an ActiveX™ control, a script, or some other component of firmware or software for performing a computational task.

The descriptions of elements within the figures may involve certain actions by either a client device or a user of the client device. One of ordinary skill in the art would understand that requests and/or responses to/from a client device are sometimes initiated by a user and at other times are initiated automatically by a client, often on behalf of a user of the client. Hence, when a client or a user of a client is mentioned in the description of the figures, it should be understood that the terms “client” and “user” can often be used interchangeably without significantly affecting the meaning of the described processes.

The descriptions of the figures herein may involve an exchange of information between various components, and the exchange of information may be described as being implemented via an exchange of messages, e.g., a request message followed by a response message. It should be noted that, when appropriate, an exchange of information between computational components, which may include a synchronous or asynchronous request/response exchange, may be implemented equivalently via a variety of data exchange mechanisms, such as messages, method calls, remote procedure calls, event signaling, or other mechanism.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for performing authorization operations with respect to a set of computational resources in a data processing system, the method comprising:
automatically permitting access to an authorized subset of computational resources for a first person;
automatically determining a first physical location for the first person and a second physical location for a second person using one or more personal proximity detection devices;
computing a spatial relationship between the first physical location and the second physical location; and
automatically modifying the authorized subset of computational resources based on the spatial relationship.

2. The method of claim 1 further comprising:
denying access by the first person to a resource in the modified authorized subset of computational resources.

3. The method of claim 1 further comprising:
evaluating an authorization policy to determine the authorized subset of computational resources.

4. The method of claim 1 further comprising:
computing a physical distance between the first physical location and the second physical location; and
performing a modification of the authorized subset of computational resources using the computed physical distance as an input to determining the spatial relationship.

5. The method of claim 1 further comprising:
performing a modification of the authorized subset of computational resources in response to a determination that the first physical location and the second physical location are contained within a common physical structure.

6. The method of claim 1 further comprising:
retrieving a first authorization policy that is associated with the first person;
determining a first subset of computational resources that is permitted to be accessed by the first person in accordance with the first authorization policy;
retrieving a second authorization policy that is associated with the second person;
determining a second subset of computational resources that is permitted to be accessed by the second person in accordance with the second authorization policy; and
comparing the first subset of computational resources and the second subset of computational resources.

7. The method of claim 6 further comprising:
computing an intersecting subset of computational resources between the first subset of computational resources and the second subset of computational resources; and
restricting the modified authorized subset of computational resources for the first person to be equal to or less than the intersecting subset of computational resources.

8. The method of claim 6 further comprising:
enhancing the modified authorized subset of computational resources for the first person to include a computational resource from the second subset of computational resources that is permitted to be accessed by the second person.

9. The method of claim 1 further comprising:
receiving information in a wireless signal from a portable electronic device that is associated with a person; and
determining a physical location for a person based on the received wireless signal.

10. A computer program product on a computer-readable storage medium for use in a data processing system for performing authorization operations with respect to a set of computational resources, the computer program product comprising:
means for automatically permitting access to an authorized subset of computational resources for a first person;
means for automatically determining a first physical location for the first person and a second physical location for a second person using one or more personal proximity detection devices;
means for computing a spatial relationship between the first physical location and the second physical location; and
means for automatically modifying the authorized subset of computational resources based on the spatial relationship.

11. The computer program product of claim 10 further comprising:
means for denying access by the first person to a resource in the modified authorized subset of computational resources.

12. The computer program product of claim 10 further comprising:
means for evaluating an authorization policy to determine the authorized subset of computational resources.

13. The computer program product of claim 10 further comprising:
means for computing a physical distance between the first physical location and the second physical location; and
means for performing a modification of the authorized subset of computational resources using the computed physical distance as an input to determining the spatial relationship.

14. The computer program product of claim 10 further comprising:
means for performing a modification of the authorized subset of computational resources in response to a determination that the first physical location and the second physical location are contained within a common physical structure.

15. The computer program product of claim 10 further comprising:
means for receiving information in a wireless signal from a portable electronic device that is associated with a person; and
means for determining a physical location for a person based on the received wireless signal.

16. The computer program product of claim 10 further comprising:
means for retrieving a first authorization policy that is associated with the first person;
means for determining a first subset of computational resources that is permitted to be accessed by the first person in accordance with the first authorization policy;
means for retrieving a second authorization policy that is associated with the second person;
means for determining a second subset of computational resources that is permitted to be accessed by the second person in accordance with the second authorization policy;
means for computing an intersecting subset of computational resources between the first subset of computational resources and the second subset of computational resources; and
means for restricting the modified authorized subset of computational resources for the first person to be equal to or less than the intersecting subset of computational resources.

17. The computer program product of claim 10 further comprising:
means for retrieving a first authorization policy that is associated with the first person;
means for determining a first subset of computational resources that is permitted to be accessed by the first person in accordance with the first authorization policy;
means for retrieving a second authorization policy that is associated with the second person;
means for determining a second subset of computational resources that is permitted to be accessed by the second person in accordance with the second authorization policy;
means for enhancing the modified authorized subset of computational resources for the first person to include a computational resource from the second subset of computational resources that is permitted to be accessed by the second person.

18. An apparatus for use in a data processing system for performing authorization operations with respect to a set of computational resources, the apparatus comprising:
means for automatically permitting access to an authorized subset of computational resources for a first person;
means for automatically determining a first physical location for the first person and a second physical location for a second person using one or more personal proximity detection devices;
means for computing a spatial relationship between the first physical location and the second physical location; and
means for automatically modifying the authorized subset of computational resources based on the spatial relationship.

19. The apparatus of claim 18 further comprising:
means for denying access by the first person to a resource in the modified authorized subset of computational resources.

20. The apparatus of claim 18 further comprising:
means for retrieving a first authorization policy that is associated with the first person;
means for determining a first subset of computational resources that is permitted to be accessed by the first person in accordance with the first authorization policy;
means for retrieving a second authorization policy that is associated with the second person;
means for determining a second subset of computational resources that is permitted to be accessed by the second person in accordance with the second authorization policy;
means for computing an intersecting subset of computational resources between the first subset of computational resources and the second subset of computational resources; and
means for restricting the modified authorized subset of computational resources for the first person to be equal to or less than the intersecting subset of computational resources.
